(19) United States
(12) Patent Application Publication
(10) Pub. No.: US 2019/0164421 A1
(43) Pub. Date: May 30, 2019

(54) METHOD FOR CONTROLLING AIR-CONDITIONING COMPONENTS OF A MOTOR VEHICLE

(71) Applicant: Continental Automotive GmbH, Hannover (DE)

(72) Inventors: Stefan Lauer, Beratzhausen (DE); Christoph Baumgärtner, Regenstauf (DE); Friedrich Graf, Sinzing (DE); Franz Pellkofer, Nittendorf (DE)

(21) Appl. No.: 16/308,108

(22) PCT Filed: Jun. 6, 2017
(86) PCT No.: PCT/EP2017/063708

§ 371 Date: Dec. 7, 2018

(30) Foreign Application Priority Data
Jun. 8, 2016 (DE) 10 2016 210 130.7

(51) Int. Cl. G08G 1/0967; B60H 1/00

(52) U.S. Cl. CPC G08G 1/096775; B60H 1/00742; B60W 40/06; G08G 1/096725; B60H 1/00778

(57) ABSTRACT

A method for controlling air-conditioning components of a motor vehicle is described. A forecast vehicle temperature is ascertained. Further, a probable air-conditioning time for the motor vehicle is ascertained. Also, a setpoint temperature control state is prescribed. An air-conditioning requirement is ascertained on the basis of a comparison between the forecast vehicle temperature and the setpoint temperature control state. At least one air-conditioning component is actuated according to the air-conditioning requirement before the probable air-conditioning time with the control target of reaching the setpoint temperature control state at the beginning of the air-conditioning time.

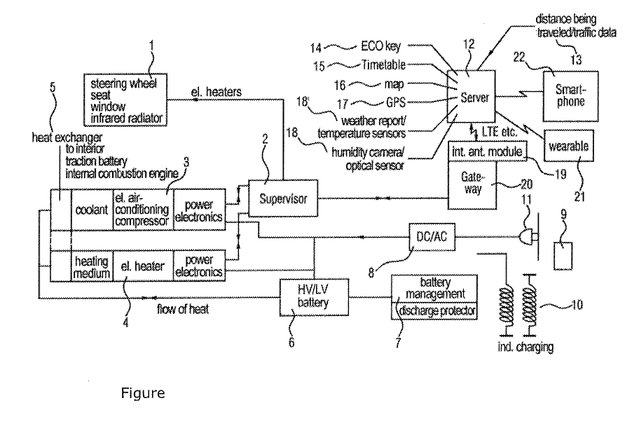

### CROSS REFERENCE TO RELATED APPLICATIONS

This application is the U.S. National Phase Application of PCT International Application No. PCT/EP2017/063708, filed Jun. 6, 2017, which claims priority to German Patent Application No. 10 2016 210 130.7, filed Jun. 8, 2016, the contents of such applications being incorporated by reference herein.

### BACKGROUND OF THE INVENTION

Motor vehicles have an interior that can be air-conditioned by means of an air-conditioning system. The air-conditioning power, i.e. the cooling power or heating power, is adjusted by using user interfaces that are in the central console. There, it is possible to set a temperature value during use of the vehicle, which is used as a regulation target for the air-conditioning system from the time at which the regulation target was input.

In particular at the beginning of a journey, there can be a large difference between actual and setpoint temperatures that firstly requires a high air-conditioning power and secondly represents low comfort for the user.

### SUMMARY OF THE INVENTION

An aspect of the invention is a way in which better air-conditioning control can be achieved.

A method for controlling air-conditioning components of a motor vehicle is described. A forecast vehicle temperature (as a temperature value or as a weather property that can be associated with a temperature range) is ascertained. The vehicle temperature can relate to the interior of the vehicle, to individual air-conditioning zones or seat positions of the vehicle or to components such as the battery. Further, a probable air-conditioning time for the motor vehicle is ascertained. This is consistent with a forecast for a period or time during which or from which the motor vehicle or components thereof should be air-conditioned, i.e. should have a determined temperature or a determined state (de-iced, heated). Further, a setpoint temperature control state is prescribed. An air-conditioning requirement is further ascertained on the basis of a comparison between the forecast vehicle temperature and the setpoint temperature control state. The air-conditioning requirement is greater the larger the difference between the forecast vehicle temperature and the setpoint temperature control state. At least one air-conditioning component is actuated according to the air-conditioning requirement before the probable air-conditioning time with the control target of reaching the setpoint temperature control state at the beginning of the air-conditioning time. To this end, the temperature control power (i.e. cooling or heating power), the period of actuation of the air-conditioning component in the active state, or both, can be adjusted such that the control target is achieved with a prescribable accuracy. The control target may in particular be consistent with a regulation target.

Therefore, the following steps are performed (mentioned again to provide a better overview):
a) ascertaining a forecast vehicle temperature;
b) ascertaining a probable air-conditioning time for the motor vehicle;
c) prescribing a setpoint temperature control state;
d) ascertaining an air-conditioning requirement on the basis of a comparison between the forecast vehicle temperature and the setpoint temperature control state; and
e) actuating at least one air-conditioning component according to the air-conditioning requirement before the probable air-conditioning time with the control target of reaching the setpoint temperature control state at the beginning of the air-conditioning time.

The use of a forecast value allows in particular comfort to be increased, since air-conditioning begins before actual use and, further, can have its power adjusted on the basis of the forecast vehicle temperature. This also permits automation, especially since said steps can be performed by one or more apparatuses.

Steps a)-d) can be performed in a stationary server and the air-conditioning requirement can be transmitted to the motor vehicle. In this instance, these steps can be performed in the server for multiple vehicles. Also, the server can be a computer of a user who is outside the vehicle, in which case the steps are preferably performed only for a vehicle of the user or only for the vehicles of the user. Further, these steps can be performed in a (mobile) user device. The actuating step is performed in a controller of the motor vehicle. Relevant data can be transmitted between a user device and the vehicle, either directly or via the server. Further, steps a)-d) can be performed in the vehicle.

The prescribing of a setpoint temperature control state can also be accomplished in person-related fashion or in a manner transferrable to different vehicles. The setpoint temperature control state can be stored together with personal data. This allows the setpoint temperature control state (of the same person) to be transferred from one vehicle to another, for example when the person changes vehicle. In particular, this allows a user to carry setpoint temperature control states with him, for example stored on a smartphone, and to transfer them to continually or only temporarily used vehicles (rental car, taxi). In this instance, there can be provision for an application program on the smartphone, for example, which is used to transfer a setpoint temperature control state (personalized for the user) to the vehicle used by the user. The setpoint temperature control data can be transferred automatically as soon as a data-transferring connection is obtained between the smartphone and the vehicle (and if need be an acceptance confirmation has been input on the vehicle). The setpoint temperature control data may further be linked to a value for a level of customization. The level of customization indicates whether customization is to be optimized for comfort (for example the speed of adjustment and/or an accuracy of adjustment), on the one hand, or for energy efficiency (according to an eco mode). The level of customization indicates the weighting of the two cited optimization targets. The weighting of one target is lower the higher the weighting of the other target.

The ascertaining of the forecast vehicle temperature can comprise ascertaining forecast precipitation data, temperature data or humidity data on the basis of a weather report of a weather service or on the basis of sensors. The sensors are in particular vehicle-based sensors, for example a motor-vehicle-based temperature sensor, a humidity sensor, a light irradiation sensor. Further, a motor-vehicle-based camera can be used, the image from which is evaluated with the stipulation of detecting fallen precipitation (for example snow, hail, sleet or rain) or falling precipitation (for example snow, hail, sleet or rain).

The ascertaining of forecast precipitation data, temperature data or humidity data can be performed on the basis of a weather report of a weather service in a stationary server or in a user device or on the vehicle. Thus, the server, the vehicle or the smartphone can access the weather service. The ascertaining on the basis of sensors can comprise: transmitting sensor data of the sensors from the motor vehicle to the stationary server and evaluating the data (of the sensor or of the weather service) by means of the server. Further, the data can be evaluated (and transferred to the vehicle) by a smartphone or can be (received and) evaluated on the vehicle.

The step of ascertaining a probable air-conditioning time can be accomplished by virtue of a probable air-conditioning time being received from a user device, in particular in personalized fashion and/or from a calendar application program of a user device. Further, a probable air-conditioning time can be derived from historic detected air-conditioning times of the motor vehicle. Also, the probable air-conditioning time can be derived, in particular by means of a navigation device, from a planned future route received from a user device. In this instance, the journey time is estimated on the basis of the route and the start of the air-conditioning time is consistent with a prescribed (or historically detected) arrival time minus the journey time, for example. The journey time can take into consideration the traffic conditions, in particular the messages of a traffic service. Finally, the air-conditioning time can be ascertained in a manner linked to a user as a personalized air-conditioning time. A further aspect is acquisition of the air-conditioning time. The air-conditioning time can relate to use of the motor vehicle, i.e. relates to the interval of time conveying the phase of presence of the user in the vehicle. Further, it can relate to use of an internal combustion engine in the motor vehicle. In hybrid vehicles, the internal combustion engine is switched off for purely electric driving, in particular. The air-conditioning time can relate to that proportion of time of use of the vehicle during which the internal combustion engine is active. The air-conditioning time may further be an interval of time that begins when the vehicle is switched off or parked. This is in particular the case when exterior temperatures are outside a prescribed temperature range, for example below −10° C. or above 40° C., and, for example, a battery is disconnected in a heated state in a cold environment and is disconnected in a cooled state in a warm environment, in order to achieve the effect that the battery is still at a temperature within an operating temperature window some time after being disconnected. Further, actuating at a time that is a determined period before the end of the probable end of use allows a vehicle component such as the battery to be pre-conditioned (for temperature) prior to disconnection, for example in order to reduce or avoid temperature control measures after the end of use of the vehicle (for example fan run-on). Also, the air-conditioning components can be actuated when the vehicle is stationary and electric power is transferred between the vehicle and a stationary electrical supply system, for example by means of cable or inductively.

Actuating at least one air-conditioning component according to the air-conditioning requirement before the probable air-conditioning time with the control target of reaching the setpoint temperature control state at the beginning of the air-conditioning time. In this instance, cold or heat can be stored in a vehicle component (for example the battery), for example in view of the temperature control requirement, by virtue of only the air-conditioning component that cools or heats the vehicle component being actuated, preferably before the air-conditioning time and in particular such that at the beginning of the air-conditioning time the vehicle component has reached a setpoint temperature (or the planned amount of cold or heat has been absorbed completely). Actuating can thus be in two stages and initially relate to (only) one air-conditioning component of a vehicle component (for example the battery) and, in a later phase, relate to an air-conditioning component that controls the temperature of the vehicle interior.

Data (relating to the probable air-conditioning time and/or to the setpoint temperature control state) can be received by the motor vehicle. The data can be sent by a user device or by a stationary server communicating with the user device. The user device can be a wireless communication device, in particular a smartphone, a mobile-radio-enabled tablet computer or a mobile-radio-enabled wearable, for example a mobile-radio-enabled armband.

The prescribing of the setpoint temperature control state comprises in particular transmitting the setpoint temperature control state by means of a user device or by means of a central server to the motor vehicle. Alternatively, the setpoint temperature control state can be input on a user interface of the vehicle. A setpoint temperature control state can be represented by: a setpoint interior temperature, a setpoint traction battery temperature, a setpoint internal combustion engine temperature, a heated steering wheel, in particular heated to a setpoint temperature, a heated vehicle seat, in particular heated to a setpoint temperature, or a defrosted rear window or windshield.

The step of actuating an air-conditioning component can be performed by actuating a mechanical or electrical air-conditioning compressor, an interior heater, a battery heater, an auxiliary heater, a seat heater, a window heater, a steering wheel heater or an IR radiator pointing at a window or into the interior. The actuating step can be performed while the vehicle is provided with electric power by a charging station or feeds electric power back thereto. In particular, some or all of the air-conditioning component is supplied with power by the charging station in this instance.

The setpoint temperature control state can comprise multiple individual states. These are associated with different locations (in the vehicle interior), in particular different passenger positions in the interior of the motor vehicle. The air-conditioning component can be actuated differently for air-conditioning the different locations.

An apparatus for performing the method can have: a mechanical or electrical air-conditioning compressor, an electric heater or an auxiliary heater, via at least one electric heaters on: seat, windows, steering wheel, or an IR radiator. The charging (during the controlling step can be performed by cable or inductively,

The method is used for cooling or heating an interior, a traction battery or another battery and/or an internal combustion engine. The battery can serve as a heat reservoir for the interior. This is possible if an air-conditioning component that cools or heats the battery is actuated and at a later time an air-conditioning component that is configured to transport cold or heat from the battery to the interior is actuated.

An “eco key”, an operator control element, can be used to receive a user input indicating the extent to which actuation is optimized in the direction of energy efficiency, or the extent to which actuation is optimized in the direction of comfort (i.e. precision in keeping to the setpoint temperature control state).

The forecast vehicle temperature or the probable air-conditioning time can be ascertained on the basis of:
a timetable, calendar matching,
time-controlled temperature control using learned habits, e.g. historic data (captured in the past), i.e. setpoint temperature control state data. These can be ascertained and stored on the basis of location, i.e. with an indication of the location that the vehicle was at at the time at which the data were captured.
a weather report (of a weather service),
on the basis of temperature sensors, in particular in combination with humidity,
on the basis of an optical sensor for detecting condensation or ice formation.

A further aspect is personalization of the setpoint temperature control state data. In this instance, a personal profile (conveying at least one setpoint temperature control state) can be transportable between different vehicles. This allows the personal profile to be transferred to a seat in a strange vehicle (i.e. one not continually associated with the user), e.g. in a taxi or rental car.

There can be a connection between the user device and the vehicle directly, or the connection can run via the server. Instead of the server, a computer can also be used in the vehicle in order to perform the functions of the server. The server can be realized by a distributed system, for example in the form of a server factory. Also, a computer associated with the user can perform the function of the server, this being located in particular in a residential building of the user.

Multiple profiles can be managed at the same time or by the same unit. The profile may further be specified according to an association with different air-conditioning zones in the vehicle.

Actuation can also involve cooling from reserve, i.e. cooling to a greater extent than the setpoint air-conditioning state indicates, for example during a charging process for the vehicle. Further, it is possible to heat in advance if a future time at which the internal combustion engine of the vehicle will be switched off (in the case of further use of the vehicle) has been ascertained. This is the case in particular when changing to purely electric driving of a hybrid vehicle.

Further, actuating can provide for discharge protection for the battery; if the state of charge is below a prescribed minimum, then actuating is not continued or is continued at reduced power. Also, there can be provision for the air-conditioning component(s) to be actuated by drawing power from the battery or from the electrical supply system (in the case of a plug-in hybrid) on the basis of the expected/most probable distance being traveled. The power requirement for the air-conditioning is ascertained on the basis of the distance being traveled. If there is still (at least) a prescribed minimum amount of power in the battery after (computed, not actual) deduction of this power requirement, then the battery can be used. Ascertainment of the power requirement takes into consideration the amount of regenerated power to be expected for the distance being traveled.

The approach described here is in particular also suitable for low-voltage hybrids (48V)/plug-in hybrid vehicles.

Further, as an option, instead of actuation before the air-conditioning time, actuation is effected thereafter for the purposes of re-conditioning after switching off in a hot (desert) or cold (Arctic climate) environment. Also, it is optionally possible for the battery to be pre-conditioned before the vehicle is switched off by actuating a battery air-conditioning component, in particular in order to avoid protective functions after the vehicle is switched off (for example fan run-on).

### BRIEF DESCRIPTION OF THE DRAWINGS

The figure shows an exemplary overall system to explain the approach described here.

### DETAILED DESCRIPTION OF THE PREFERRED EMBODIMENTS

Air-conditioning components 1, for example a steering wheel heater, a seat heater, a window heater and/or an infrared radiator as electric heaters, are actuated by a vehicle-based controller 2. The controller 2 operates as a supervisor. The controller 2 further actuates an electrical air-conditioning compressor 3 by means of associated power electronics and an electric heater 4 by means of associated power electronics.

There can be provision for a heat exchanger 5 (or a coolant circuit) that sets up a heat-transferring connection between the air-conditioning compressor 3 and the heater 4, on the one hand, and a vehicle interior, a (traction) battery 6 of the vehicle or an internal combustion engine, on the other hand. The heat exchanger 5 can be regarded as part of an air-conditioning component or as an air-conditioning component itself and is preferably actuated by the controller 2. The figure depicts the flow of heat or the heat-transferring connection between the air-conditioning compressor 3 and the heater 4, on the one hand, and the battery 6, on the other hand.

The battery 6 can be a high-voltage battery (operating voltage at least 60 V, 100 V, 200 V or 350 V), or can be a battery having an operating voltage of less than 60 volts, in particular having an operating voltage of 12 V, 24 V, 36 V or 48 volts. The battery 6 has an associated battery management unit that in particular implements the function of a discharge protector. The air-conditioning compressor 3 and the heater 4 can be supplied with power either by the battery 6 or by a stationary power supply system 9 via a rectifier 8. The connection provided can be an inductive connection 10 and/or a line-based connection 11. The rectifier 8 can be bidirectional (i.e. capable of a return feed) and hence also have an inverter function.

A distance being traveled and associated traffic data 13 can be input into a server 12. Further, an eco user interface 14 can be connected to the server 12 (for example in stationary fashion or in the form of a vehicle-based computer). The server can further receive calendar data 15 indicating the (planned) use of the vehicle, map data 16, position data 17 and further data 18, wherein the further data are, for example, a weather report (reference sign 18′) of a weather service or sensor data (in particular of the vehicle), for example data of a temperature sensor or of a humidity sensor or data that have been extracted from a camera image or data of an optical sensor. The latter two variants are data conveying weather conditions, in particular on the road or on the route ahead. This also applies to the weather report. The sensor data are denoted by the reference sign 18.

The vehicle comprises an antenna module 19 connected to a gateway 20. The gateway 20 and the antenna module 19 are on the vehicle. In the figure, the server is not accommodated on the vehicle, which means that there is provision for a mobile radio connection between the server 20 and the antenna module 19. The server 20 can further be connected to a mobile user device in data-transferring fashion. A possible mobile user device is a mobile-radio-enabled armband 21 (“wearable”) or a smartphone 22, for example. The server can transfer states to the mobile user device and the mobile user device can display said states. Further, the mobile user device can store at least one setpoint temperature control state, preferably in personalized and/or location-related fashion, wherein the setpoint temperature control state can be transferred to the server 12 (depicted) or can be transferred to the gateway 20 directly via the antenna module 19 (not depicted).

1.-10. (canceled)

11. A method of controlling air conditioning components of a motor vehicle comprising:
a) determining a predicted vehicle temperature;
b) determining an expected air conditioning time of the motor vehicle;
c) specifying a desired temperature state;
d) determining an air conditioning requirement based on a comparison between the predicted vehicle temperature and the desired temperature state; and
e) driving at least one air conditioning component according to the air conditioning requirement prior to the expected air conditioning time with a control target of reaching the desired temperature state at the beginning of the expected air conditioning time,
wherein a two-step driving is performed and first an air conditioning component of a vehicle component is concerned, and in a later phase an air conditioning component is concerned which does climate control of the interior of the vehicle.

12. The method of claim 11, wherein the vehicle component is a battery.

13. The method of claim 11, wherein the steps a)-d) are performed in a stationary server and the air conditioning requirement is transmitted to the motor vehicle, wherein the step of driving at least one air conditioning component according to the air conditioning requirement is executed in a controller of the motor vehicle.

14. The method of claim 13, wherein determining the predicted vehicle temperature comprises: determining predicted precipitation data, temperature data or humidity data from a weather report of a weather service or sensors selected from the group consisting of a motor vehicle side temperature sensor, a humidity sensor, a light sensor, or a camera on a side of the vehicle, an image of which is evaluated to detect precipitation.

15. The method according to claim 11, wherein for the step b) an expected air conditioning time is received from a user device and/or from a calendar application program of a user device, a probable air conditioning time is derived from historical detected air conditioning times of the motor vehicle, the expected air conditioning time is derived from a planned future route received from the user device, or the air conditioning time is determined linked to a user as a personalized air conditioning time.

16. The method according to claim 11, wherein for the step b) the air conditioning time refers to the use of the motor vehicle or refers to the use of an internal combustion engine in the motor vehicle.

17. The method according to claim 11, wherein the step c) comprises: transmitting the desired temperature state by a user device or by a central server to the motor vehicle or inputting the desired temperature state to a user interface of the vehicle, wherein a desired temperature condition is represented by: a desired interior temperature, a target traction battery temperature, a target engine temperature, a heated steering wheel, a heated vehicle seat, a defrosted rear windscreen, or a defrosted front windscreen.

18. The method according to claim 11, wherein step e) comprises: controlling a mechanical or electrical air conditioning compressor, an interior heater, a battery heater, a heater, a seat heater, a window heater, a steering wheel heater or an IR radiator.

19. A method of operating climate control components of a motor vehicle comprising:
determining a predicted vehicle temperature,
determining an expected time for temperature control of the motor vehicle,
specifying a desired target temperature state,
determining a climate control requirement based on a comparison between the predicted vehicle temperature and the desired temperature state,
driving at least one climate control component according to the climate control requirement prior to the expected temperature control time with the target of reaching the desired temperature state at the beginning of the expected temperature control time,
wherein a two-step driving is performed and first climate control of a vehicle battery is performed, and in a later phase climate control for the interior of the vehicle is performed.

20. The method according to claim 19, wherein climate control components comprise a mechanical or electrical air conditioning compressor, an interior heater, a battery heater, a heater, a seat heater, a window heater, a steering wheel heater or an IR radiator.

21. The method according to claim 20, wherein the driving of the at least one climate control component is carried out while the vehicle receives electrical energy from a charging station and at least partially or completely supplies the climate control component from the charging station.

22. The method according to claim 19, wherein the desired temperature state is transferred to the user's vehicle from an application program on a smartphone.

23. A method of operating climate control components of a motor vehicle comprising:
determining an expected time and a predicted temperature for temperature control of the motor vehicle;
identifying a desired target temperature state;
determining a climate control requirement based on a comparison between the predicted vehicle temperature and the desired temperature state;
operating at least one climate control component for climate control of an interior of the vehicle prior to the expected time for temperature control with the target of reaching the desired target temperature state at the beginning of the expected temperature control time,
wherein climate control of a vehicle battery is performed prior to the climate control of the interior of the vehicle.

24. The method of claim 23, wherein the determining the expected time and the predicted temperature are performed in a stationary server.

25. The method of claim 23, wherein the operating the at least one climate control component and performing climate control of a vehicle battery is executed in a controller of the motor vehicle.

26. The method of claim 23, wherein determining the predicted vehicle temperature comprises: determining predicted precipitation data, temperature data or humidity data from a weather report of a weather service or sensors selected from the group consisting of a motor vehicle side temperature sensor, a humidity sensor, a light sensor, or a camera on a side of the vehicle.

27. The method of claim 12, wherein the steps a)-d) are performed in a stationary server and the air conditioning requirement is transmitted to the motor vehicle, wherein the step of driving at least one air conditioning component according to the air conditioning requirement is executed in a controller of the motor vehicle.
